(19) United States
(12) Patent Application Publication
(10) Pub. No.: US 2007/0174836 A1
(43) Pub. Date: Jul. 26, 2007

(54) System for controlling computer and method therefor

(76) Inventors: Naomi Ito, Yokohama (JP); Takaichi Ishida, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/372,006

(22) Filed: Mar. 10, 2006

(30) Foreign Application Priority Data
Jan. 24, 2006 (JP) 2006-014980

(51) Int. Cl. G06F 9/455

(52) U.S. Cl. 718/1

(57) ABSTRACT

In an information processing system that has a computer communicable with a terminal for sending a predetermined request and equipped with not less than two virtual computer for processing the request received from the terminal, and an operation management apparatus communicable with the virtual computers and for performing a reset processing instruction to the virtual computers: the computer control method of the present invention is for opening a memory area of the virtual computers, wherein the operation management apparatus includes a memory unit for managing the virtual computers within the computer, sequentially performs the reset processing one by one with respect to the virtual computers managed by the memory unit, and wherein when the virtual computers receive the reset processing instruction from the operation management apparatus, the virtual computers perform own reset processing.

### BACKGROUND OF THE INVENTION

1. Field of the Invention

The present invention relates to a computer control system of a virtual computer, an information processing system, an operation management apparatus, a computer, and a computer control program.

2. Description of the Related Art

In some case a processing efficiency of a computer lowers as utilization thereof elapses. It is known that this phenomenon is due to such a programming error that processing for opening a memory area once ensured is not described in a program run by computer, and the phenomenon is called software aging. With respect to the software aging, there exists a technology of recovering an original processing efficiency by resetting a program for every processing time (for example, see U.S. Ser. No. 09/442,003 (Japanese Patent Laid-Open Publication No. 2001-188684)). Here, a reset is processing of opening a memory area which a program has ensured: for example, a restart of a program and processing called FULLGC (Full Garbage Collection). For example, in the U.S. Ser. No. 09/442,003 is also disclosed such a technology that recovers the processing efficiency by resetting an application and a system for every predetermined time.

However, in a case that a program is reset in a computer, there is a problem that a service cannot be provided by system before the program is restarted and becomes a processable status.

For example, in an application server for implementing J2EE (Java 2 Enterprise Edition: registered trademark), if the FULLGC is performed for opening an unused memory area as part of reset processing, a processing efficiency of the application server lowers, and in some case it becomes difficult to maintain a target performance of a service. Particularly, in a case that a large scale virtual memory area is allocated to an application server in such a multiprocessor system, the lowering of the processing efficiency of the application server in total by the FULLGC is very remarkable.

In addition, in a configuration of equally allocating a request from a terminal to a plurality of application servers by load dispersing apparatus, a time when the FULLGC is performed results in an approximately same time zone in each of the application servers, and the lowering of a processing efficiency results in occurring in a total system configured with the plurality of the application servers.

Consequently, in view of the problem the present invention is configured to suppress lowering of a processing efficiency of a total system in a case of opening a memory area of a computer.

### SUMMARY OF THE INVENTION

The present invention to solve the problem is, in an information processing system that has a computer communicable with a terminal for sending a predetermined request and equipped with not less than two virtual computers for processing a request received from the terminal, and an operation management apparatus communicable with the virtual computers and for performing a reset processing instruction to the virtual computers, a computer control method for opening a memory area of the virtual computers, wherein the operation management apparatus comprises a memory unit for managing the virtual computers within the computer, sequentially performs the reset processing one by one with respect to the virtual computers managed by the memory unit, and wherein when the virtual computers receives the reset processing instruction from the operation management apparatus, the virtual computers perform own reset processing. Meanwhile, the present invention may also include another computer control method, information processing system, operation management apparatus, computer, and computer control program.

In accordance with the present invention, in a case of opening a memory area of a computer in a system, it is enabled to suppress lowering of a processing efficiency of a total system.

### BRIEF DESCRIPTION OF THE DRAWINGS

FIG. 1 is a drawing showing a configuration of an information processing system related to an embodiment of the present invention.

FIG. 2 is a drawing of a configuration of hardware and software of a computer.

FIG. 3 is a drawing showing a configuration of an operation management apparatus.

FIG. 4 is a drawing showing a configuration of a reset processing time setting table.

FIG. 5 is a drawing showing a configuration of a computer status management table.

FIG. 6 is a drawing showing a configuration of a load dispersing allocation management table.

FIG. 7 is a flowchart showing processing flow of a reset processing instruction unit.

FIG. 8 is a flowchart showing reset processing flow within a virtual computer.

FIG. 9 is a drawing showing a configuration of a virtual computer allocating a resource to other active virtual computers in an active system by using a technology of a dynamic logical partitioning function.

FIG. 10 is a drawing showing a configuration of virtual computers after a resource is allocated by using a technology of a dynamic logical partitioning function.

FIG. 11 is a drawing showing a configuration of a virtual computer being allocating a resource to a virtual computer for standby by using a technology of a dynamic logical partitioning function.

FIG. 12 is a drawing showing a configuration of virtual computers after a resource is allocated by using a technology of a dynamic logical partitioning function.

FIG. 13 is a drawing showing a configuration of a resource allocation management table before a resource is allocated.

FIG. 14 is a drawing showing a configuration of a resource allocation management table after a resource is allocated.

### DESCRIPTION OF THE PREFERRED EMBODIMENTS

Here will be described best embodiments for carrying out the present invention in detail, referring to drawings.

<<System Configuration and Outline>>

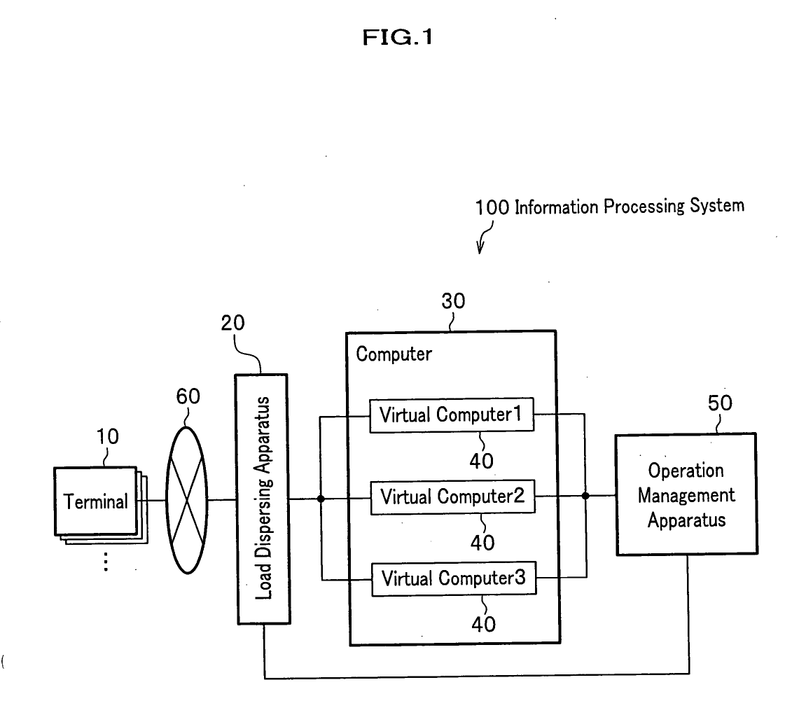

FIG. 1 is a block diagram showing a configuration of an information processing system related to the embodiments. In the embodiments will be described a reset control method of a plurality of virtual computers in an information processing system where a load dispersing apparatus equally allocates requests from terminals to the virtual computers. Here, a virtual computer is a logical computer realized by partitioning and allocating a resource such as a CPU (Central Processing Unit), a memory, and an I/O slot within one computer.

As shown in FIG. 1, an information processing system 100 in the embodiments comprises terminals 10, a load dispersing apparatus 20, a computer 30, and an operation management apparatus 50. The terminals 10 are connected to the load dispersing apparatus 20 via a network 60. The load dispersing apparatus 20 and the operation management apparatus 50 are connected to each other and to each virtual computer 40 within the computer 30. Meanwhile, although in FIG. 1 three virtual computers 40 are indicated, the embodiments of the present invention are not limited to the number.

Each terminal 10 is a terminal computer used by a user's direct operation, sends the load dispersing apparatus 20 a request according to such the user's operation, displays a result received from the apparatus 20, and makes it possible for the user to refer to the result. The load dispersing apparatus 20 receives the request from the terminal 10 and allocates it to each virtual computer 40. The computer 30 comprises not less than two virtual computers 40. Each virtual computer 40 is a computer for processing a request from any of the terminals 10 allocated by the load dispersing apparatus 20. The virtual computer 40 is realized by one or more than one CPU running a program stored in a predetermined memory. Meanwhile, the virtual computer 40 is a general name, and in a case of being individually indicated, is called a virtual computer 1, a virtual computer 2, a virtual computer 3, and the like. The operation management apparatus 50 manages a reset for each virtual computer 40 and instructs an allocation change for the load dispersing apparatus 20. The network 60 is a communication network for enabling the terminal 10 and the load dispersing apparatus 20 to be communicable with each other, and is realized, for example, by Internet, LAN (Local Area Network), radio network, telephone line network, and the like.

Here, the virtual computer 40 functions as a so called application server. The application server (program) is a kind of middleware, is positioned at midpoint between a terminal layer of a front end such as a Web browser and an enterprise information system of a back end such as a DBMS (Data Management System) and an ERP (Enterprise Resource Planning) package, and provides a run environment of a service AP (application program) and a BL (business logic). According to pervasion of the Internet and a broadband, and a maturity of a technology for realizing a high availability and reliability of a system, the application server becomes to be used not only in service system within an enterprise but also in online shopping and trading, in electronic business dealing between enterprises, and further in mission critical service.

In the embodiments, before the FULLGC is performed under a predetermined condition (for example, a remaining memory capacity is not more than a predetermined value) within a virtual computer 40, the virtual computers 40 are reset one by one at a predetermined timing, and thereby, the processing efficiency of an application server is prevented from extremely lowering due to abruptly performing the FULLGC. In performing a reset, it is adapted not to allocate a request from the load dispersing apparatus 20 to a virtual computer 40 of a would-be reset object, and to also close the virtual computer 40 of the reset object itself. In reset, although because a request from any of the terminals 10 is allocated to virtual computers 40 other than the reset object, the processing efficiency lowers a little due to a decrease of the virtual computers 40 by one for processing the request, it is adapted to be able to prevent the processing efficiency from extremely lowering in some of the virtual computers 40 due to performing the FULLGC.

Therefore, in the operation management apparatus 50 connected to the load dispersing apparatus 20 and the virtual computers 40 is managed reset processing. If it becomes a start time of a reset (according to a predetermined timing), the operation management apparatus 50 instructs each of the load dispersing apparatus 20 and the virtual computers 40 to perform an allocation change and the reset processing. With respect to the detail will be described below:

### First Embodiment

A first embodiment of the present invention is a basic embodiment related to the invention and becomes a basis of second and third embodiments.

<Configuration of Virtual Computer>

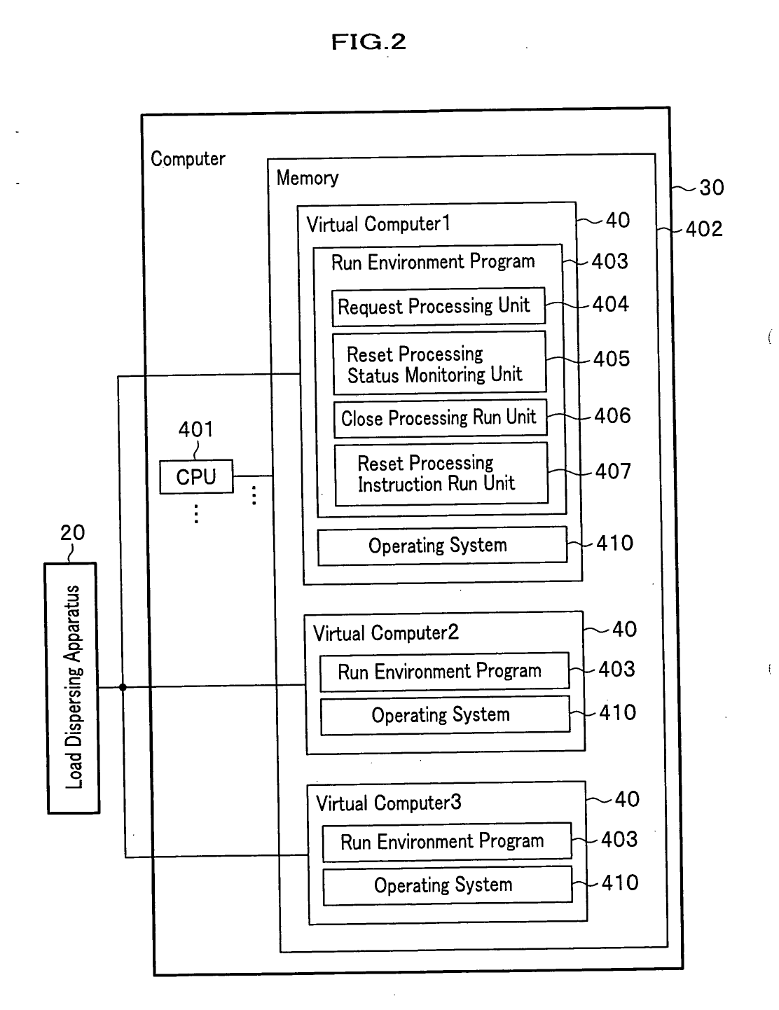

FIG. 2 is a drawing of a configuration of hardware and software of the computer 30. As shown in FIG. 2, the computer 30 related to the first embodiment comprises CPUs 401 and a memory 402.

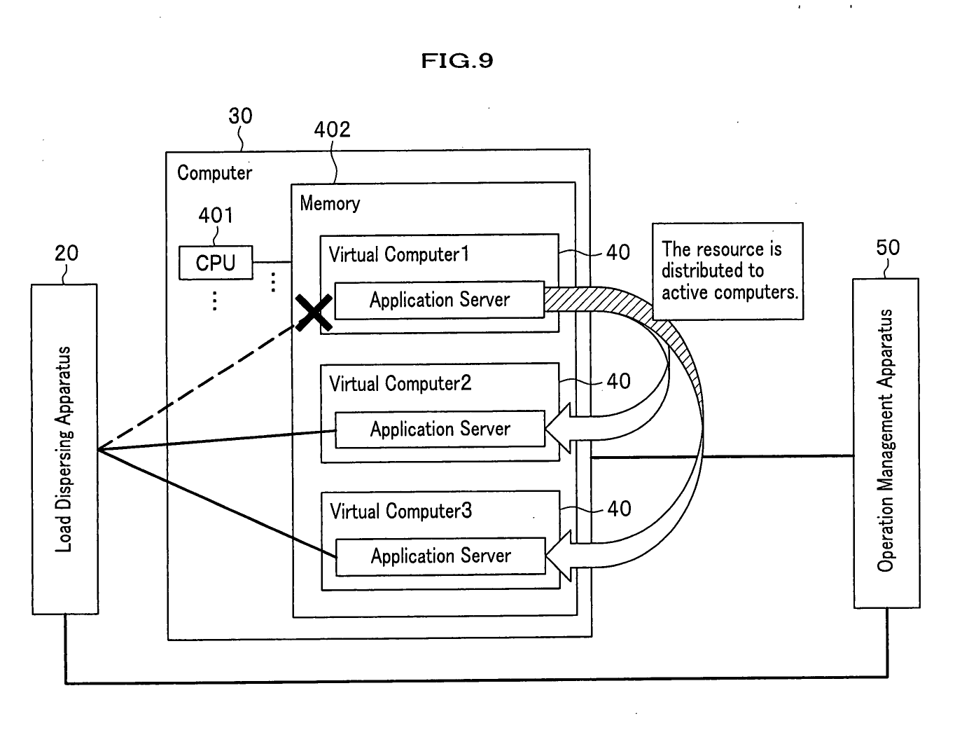

Because although the CPUs 401 are shown in FIG. 2 as not less than one, the not less than one CPU 401 is actually allocated to each virtual computer 40, not less than three CPUs 401 are equipped in a case that, for example, there exist three virtual computers 40 (also same in FIGS. 9 to 12).

Inside of the memory 402 is logically partitioned into a plurality of virtual computers 40 by using a technology of an LPAR (Logical Partitioning). The LPAR logically partitions one computer 30 into a plurality of partitions and allocates a resource (CPU, memory, I/O slot, and the like) to each of the partitions. In accordance with this, because a plurality of virtual computers 40 can be constructed in one computer 30, it is enabled to effectively utilize the computer 30. Meanwhile, although in FIG. 2 the virtual computers 40 are shown as within the memory 402, it is actually realized with a program for each of them being run by CPU 401 allocated to the computers 40 (also same in FIGS. 9 to 12).

Each virtual computer 40 comprises various programs including a run environment program 403 and an operation system 410. The run environment program 403 is a program for realizing a run environment of a program such as an application program and a business logic. The operation system 410 performs a management of a resource, control of total processing, and the like in running the programs.

The run environment program 403 comprises a request processing unit 404, a request processing status monitoring unit 405, a close processing run unit 406, and a reset processing run unit 407. The request processing unit 404 performs processing according to a request from any of the terminals 10 allocated by the load dispersing apparatus 20. To be more precise, the request processing unit 404 performs a service application program according to a request of the terminal 10.

The request processing status monitoring unit 405 monitors a processing status of a request from the terminal 10 in the request processing unit 404. It is requested that any of the virtual computers 40 related to the embodiment closes itself and processes all requests remaining inside thereof before performing reset processing, or cancels or breaks off a request in progress. Therefore, it is requested that the request processing status monitoring unit 405 monitors whether or not all requests sent to the virtual computer 40 from any of the terminals 10 is completely processed, or there exists a request in progress.

The close processing run unit 406 performs closing a virtual computer 40, In performing the reset processing as described above, the close processing run unit 406 closes the virtual computer 40, and thereby, performs so that a request is not allocated from the load dispersing apparatus 20. To be more precise, in order not to receive a new request, the close processing run unit 406 performs, for example, such processing of returning a message of “Busy.” Or else, the close processing run unit 406 is adapted not to respond to a new request. In this case the load dispersing apparatus 20 sends a request to a virtual computer 40, and when it becomes a timeout without a response thereto coming, the close processing run unit 406 is adapted not to send the request to the virtual computer 40.

The reset processing run unit 407 performs the reset processing in a virtual computer 40. To be more precise, in order to forcibly open a memory area continued to be meaninglessly ensured, the reset processing run unit 407 performs, for example, a coerce garbage collection of the memory area, a restart of the virtual computer 40, and the like. Meanwhile, the request processing unit 404, the request processing status monitoring unit 405, the close processing run unit 406, and the reset processing run unit 407 are programs.

<Configuration of Operation Management Apparatus>

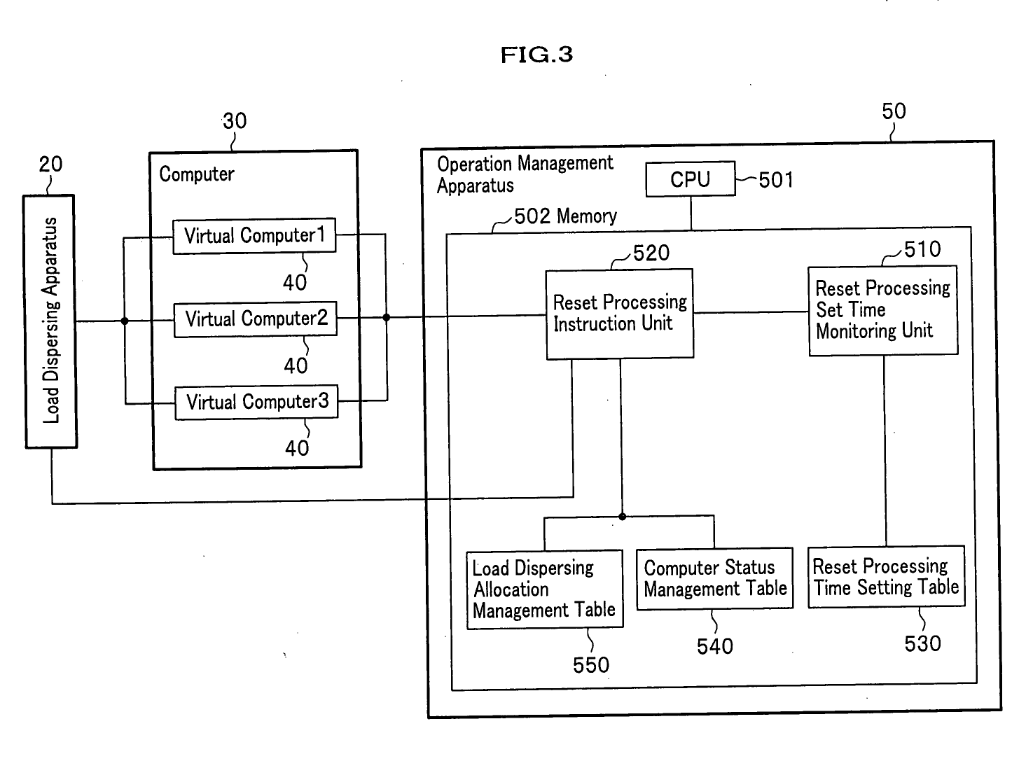

FIG. 3 is a drawing showing a configuration of the operation management apparatus 50. As shown in FIG. 3, the operation management apparatus 50 comprises a CPU 501 and a memory 502. The memory 502 comprises a reset processing set time monitoring unit 510, a reset processing instruction unit 520, a reset processing time setting table 530, a computer status management table 540, and a load dispersing allocation management table 550.

The reset processing set time monitoring unit 510 reads a value set in the reset processing time setting table 530 and monitors a set time. If it becomes a time of a read value, the reset processing set time monitoring unit 510 sends a reset processing start notice to the reset processing instruction unit 520.

If receiving the reset processing start notice from the reset processing set time monitoring unit 510, the reset processing instruction unit 520 sends an allocation change instruction and a reset processing instruction to the load dispersing apparatus 20 and any of the virtual computers 40 of a reset object, and changes statuses of the computer status management table 540 and the load dispersing allocation management table 550. The reset processing instruction unit 520 issues the allocation change instruction to the load dispersing apparatus 20 not to allocate a request from any of the terminals 10 to the virtual computer 40 of the reset object. In addition, the reset processing instruction unit 520 changes a status of the virtual computer 40 so as to correspond to the allocation change instruction in the load dispersing allocation management table 550. If the allocation change of the load dispersing apparatus 20 is completed, the reset processing instruction unit 520 sends the reset processing instruction to the virtual computer 40 of the reset object. If the rest processing is completed, the virtual computer 40 of the reset object sends a reset processing completion notice to the reset processing instruction unit 520.

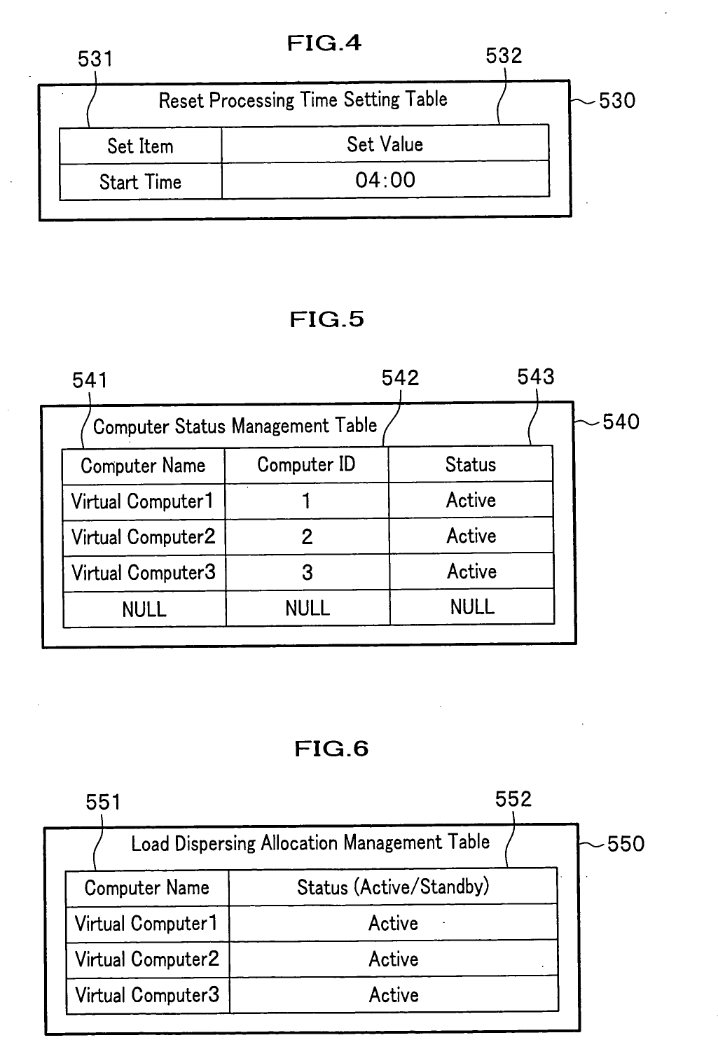

FIG. 4 is a drawing showing a configuration of the reset processing time setting table 530. The reset processing time setting table 530 is a table for registering a set time with respect to reset processing. The reset processing time setting table 530 comprises a record of which items are a set item 531 and a set value 532. The set item 531 indicates a name of a set item. The set value 532 indicates a value of a set value. In the example, because only a start time of an allocation change instruction and a reset processing instruction are set in the set item 531, as soon as the reset processing of one virtual computer 40 is over, the processing moves to a next virtual computer 40. Meanwhile, not limiting the start time to once a day, it may be set twice a day or once a period not less than two days.

In addition to the example, such a reset interval time may be further set (stored) in the set item 531 as needed. The reset interval time indicates an interval time for resetting not less than two virtual computers 40. In a case of resetting the interval time, the reset processing of a next virtual computer 40 is not performed as soon as that of a predetermined virtual computer 40 is completed, but after the reset interval time elapses from when the reset processing starts, next reset processing is adapted to be performed. In this case the reset processing set time monitoring unit 510 is adapted to monitor the reset interval time in addition to the start time.

FIG. 5 is a drawing showing a configuration of the computer status management table 540. The computer status management table 540 is a table for managing an active status of each virtual computer 40. The computer status management table 540 comprises a record of which items are a computer name 541, computer identification information (hereinafter referred to as computer ID) 542, and a status 543. The computer name 541 indicates a name of the virtual computer 40. The computer ID 542 is identification information made to correspond to the computer name 541. The status 543 indicates a status of the virtual computer 40. Although the status 543 is normally “Active,” it becomes “In Reset” in performing reset processing. In addition, in standby when a request is not allocated from the load dispersing apparatus 20, the status 543 becomes “Standby.” Meanwhile, “NULL” is set to a record next to a last effective record in each item.

FIG. 6 is a drawing showing a configuration of the load dispersing allocation management table 550. The load dispersing allocation management table 550 is a table for managing a request dispersing status of the load dispersing apparatus 20. The load dispersing allocation management table 550 comprises a record of which items are a computer name 551 and a status 552. The computer name 551 indicates a name of a virtual computer 40. The status 552 indicates whether or not the load dispersing apparatus 20 allocates a request from a terminal 10 to the virtual computer 40. In the status 552 are set “Active,” when the load dispersing apparatus 20 allocates the request; and “Standby,” when it does not allocate the request. The set value of the status 552 is updated after an allocation change of the request is completed.

<Reset Processing Instruction>

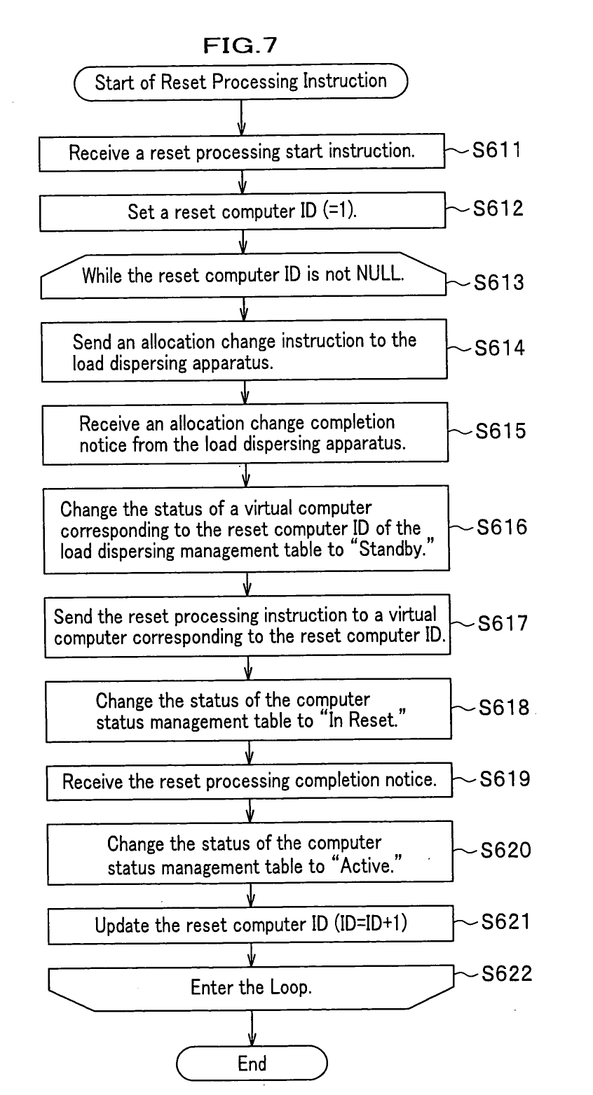

FIG. 7 is a flowchart showing processing flow of the reset processing instruction unit 520. If it becomes a start time of reset processing, the reset processing instruction unit 520 receives a reset processing start notice from the reset processing set time monitoring unit 510 (step S611). If receiving the reset processing start notice, the reset processing instruction unit 520 sets a reset computer ID (step S612). The reset computer ID indicates an order of a record in the computer status management table 540. In the embodiment, because a reset is sequentially performed, the reset processing is performed until when virtual computers 40 of records indicated by the reset computer ID are all reset, while “1” is inserted in the reset computer ID and it is updated one by one. To be more precise, in the computer status management table 540, while a reset computer ID 542 corresponding to the reset computer ID is not “Null” (step S613), processing from steps S614 to 621 is repeated (step S622).

Next will be described instruction flow until each virtual computer 40 is reset. In order to start the reset processing, the reset processing instruction unit 520 sends an instruction for a reset to the load dispersing apparatus 20 and a virtual computer 40 of the reset object. Firstly, the reset processing instruction unit 520 sends (step S614) the virtual computer 40 of the reset object an allocation change instruction not to allocate a request from a terminal 10. In this case, in one lump the reset processing instruction unit 520 sends the load dispersing apparatus 20 information for indicating whether or not to allocate the request to each virtual computer 40. Accordingly, the reset processing instruction unit 520 is adapted to further instruct a virtual computer 40 of not the reset object.

If receiving an allocation change completion notice of the request from the load dispersing apparatus 20 (step S615), the reset processing instruction unit 520 changes the status 552 of the load dispersing allocation management table 550 from “Active” to “Standby (step S616) because the virtual computer 40 of the reset object (corresponding to the reset computer ID) becomes a status that the request cannot be allocated. Because the allocation change of the request from the terminal 10 is completed, the reset processing instruction unit 520 sends the reset processing instruction to the virtual computer 40 of the reset object (step S617). Then in the computer status management table 540, the reset processing instruction unit 520 changes the status 543 corresponding to the virtual computer 40 of the reset object to “In Reset” (step S618).

If the reset processing is completed, the virtual computer 40 that received the reset processing instruction sends the reset processing completion notice to the reset processing instruction unit 520. If the reset processing instruction unit 520 receives the reset processing completion notice from the virtual computer 40 (step S619), it changes the status 543 corresponding to the virtual computer 40 to “Active” in the computer status management table 540 (step S620). Thus, with respect to one virtual computer 40, a series of processing of the reset processing instruction unit 520 ends. Subsequently, updating the reset computer ID by +1 (step S621) and referring to a next record in the computer status management table 540, the reset processing instruction unit 520 performs the reset processing instruction to the next virtual computer 40. Then the reset processing instruction unit 520 repeats the processing until the computer ID 542 becomes “NULL” (steps S613 to S622).

<Reset Processing of Virtual Computer>

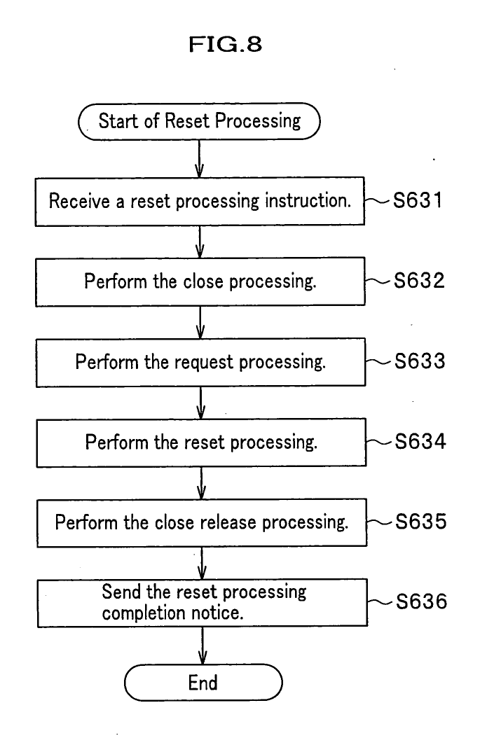

FIG. 8 is a flowchart showing reset processing flow in the reset processing run unit 407 within a virtual computer 40. If the virtual computer 40 receives a reset processing instruction from the reset processing instruction unit 520 (step S631), it starts the reset processing. Firstly, the close processing run unit 406 of the virtual computer 40 performs close processing (step S632). To be more precise, when the virtual computer 40 receives a new request, it sets a close status of returning, for example, a message of “Busy” without receiving the request. If the close processing is completed, the request processing unit 404 processes (step S633) all requests not processed and accumulated in a memory from a terminal 10 within the virtual computer 40 before the close processing. If the processing of the requests accumulated in the memory within the virtual computer 40 is completed and the virtual computer 40 becomes a status of no request remaining, the reset processing run unit 407 performs the reset processing (step S634). If the reset processing is completed, the close processing run unit 406 releases the close status of the virtual computer 40 (step S635). Then the virtual computer 40 sends a reset processing completion notice to the reset processing instruction unit 520 of the operation management apparatus 50 (step S636).

In accordance with the first embodiment of the present invention thus described, because even if performing the reset processing of a virtual computer 40, a request from any of terminals 10 is not allocated to the virtual computer 40 in the reset processing and other virtual computers 40 perform the request, then it is enabled to dispose of software aging. In addition, it is enabled to prevent a defect that a processing time of a request allocated to the virtual computer 40 in the reset processing becomes longer, and to thus suppress the lowering of the processing efficiency of the computer 30 in total.

### Second Embodiment

A second embodiment of the present invention further suppresses the lowering of the processing efficiency of the information processing system 100 in total by using a technology of a dynamic logical partitioning function. Here, the dynamic logical partitioning function enables a partition, which in one computer is virtually plurally partitioned by logical partitioning function, to be reallocated as a resource of another partition without restarting any of active virtual computers 40.

In the first embodiment, although the three virtual computers 40 normally process a request from any of the terminals 10, during the reset of one virtual computer 40 the three are reduced to two virtual computers 40 and they are requested to process the request. Whereat, with respect to the virtual computer 40 in reset, because it suffices that there exists a resource (including a CPU utilization) that can process a request remaining before close processing and can reset itself, the computer 40 does not need the resource as many as when active.

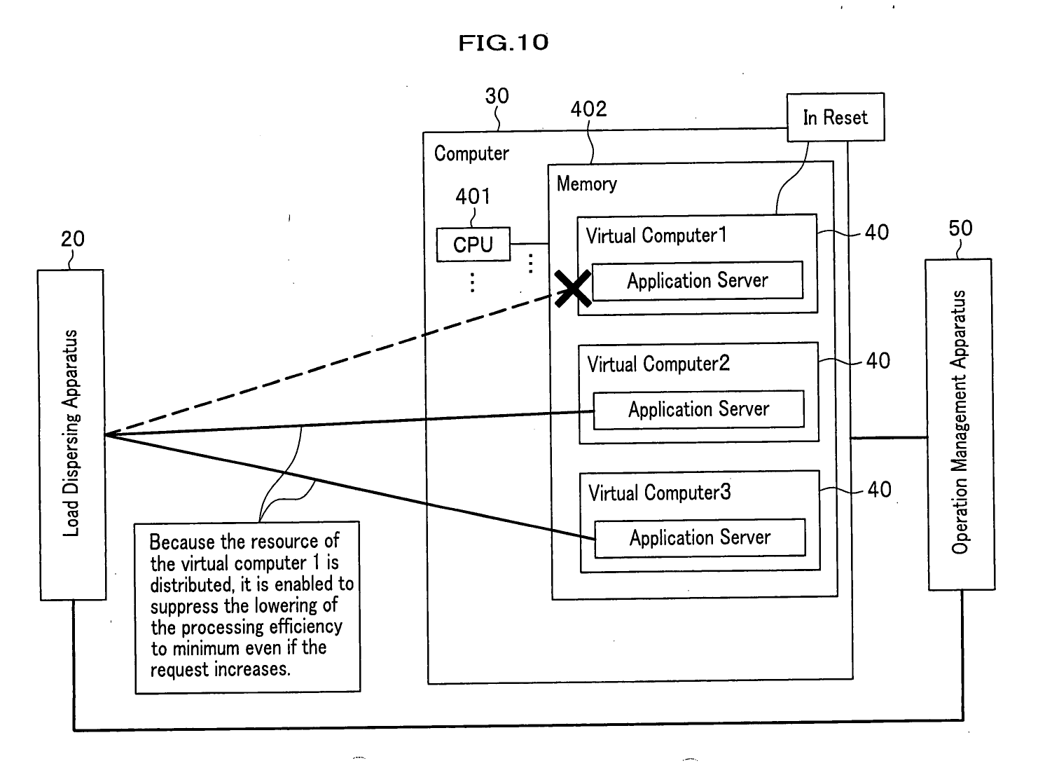

Consequently, the second embodiment uses the dynamic logical partitioning function and reallocates the resource. As shown in FIG. 9, a resource as many as that can perform reset processing is made to remain in a virtual computer 40 (virtual computer 1) of a reset object, and an extra resource is allocated to active virtual computers 40 (virtual computers 2 and 3). Doing so, as shown in FIG. 10, because even if in the virtual computers 40 (virtual computers 2 and 3) a request increases because of the existence of the virtual computer 40 (virtual computer 1) in reset, the resource is allocated and increases, the virtual computers 40 can process more requests than in normal operation and continue processing with suppressing the lowering of the processing efficiency from the normal operation to minimum.

As an actual operation, after an allocation change of a request in the load dispersing apparatus 20, the resource of the virtual computer 40 of the reset object is allocated to the active virtual computers 40. After the completion of the reset processing, the resource allocation is returned to an original status before the allocation of the request is returned. To be more precise, if a virtual computer 40 receives a reset processing instruction from the operation management apparatus 50 (step S631 in FIG. 8), a resource other than requested for the processing of a remaining request and that of the reset is allocated to other virtual computers 40 before performing close processing (step S632 in FIG. 8); and after performing close release processing (step S635 in FIG. 8), the allocated resource is returned.

In accordance with the second embodiment of the present invention thus described, because a resource of a virtual computer 40 in reset processing is allocated to other active virtual computers 40, it is enabled to further suppress the lowering of the processing efficiency even in reset.

### Third Embodiment

A third embodiment of the present invention can continue the operation of the computer 30 in total without almost lowering the processing efficiency by preparing a virtual computer 40 for standby. In normal operation of the embodiment, a request from any of the terminals 10 is not allocated to the virtual computer 40 for standby and is processed by being allocated to active virtual computers 40. The virtual computer 40 for standby has a resource at minimum, same as in the virtual computer 40 in reset described in the second embodiment.

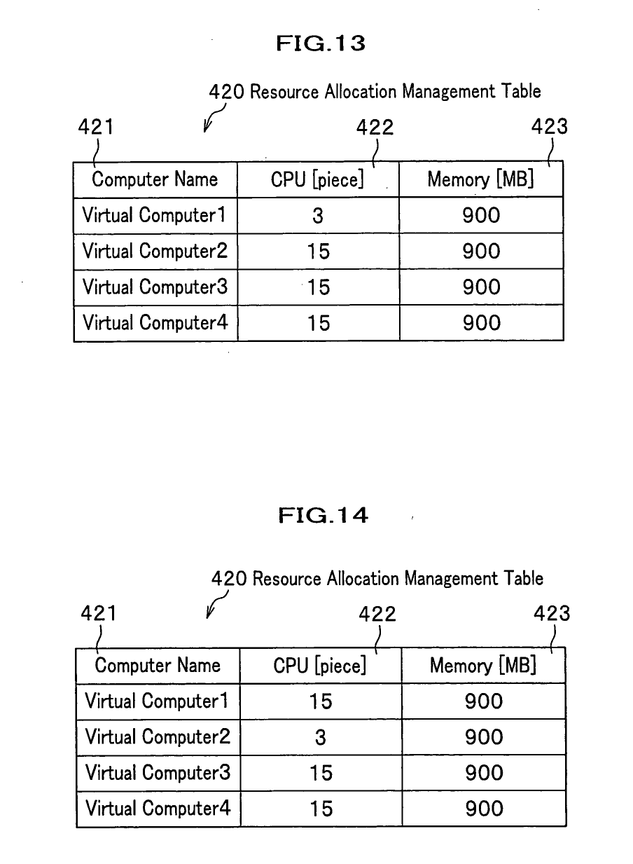

FIG. 13 is a drawing showing a concrete allocation example (status before a resource is allocated). The resource allocation management table 420 is a table for managing a resource allocation to virtual computers 40 within the computer 30. The resource allocation management table 420 comprises a record of which items are a computer name 421, a CPU 422, and a memory 423. The computer name 421 is a name of a virtual computer 40. The CPU 422 indicates a number of CPUs allocated to the virtual computer 40 indicated by the computer name 421. The memory 423 indicates a memory capacity (MByte) allocated to the virtual computer 40 indicated by the computer name 421. In total of the computer 30, although there exist 48 CPUs and a memory of 3,600 MB, CPUs are allocated less to the virtual computer 1 of a virtual computer 40 for standby. Then to other virtual computers 40 (virtual computers 2 to 4) are equally allocated the remaining CPUs. In addition, to each virtual computer 40 (virtual computers 1 to 4) is equally allocated the memory. Meanwhile, as a method of allocating the CPUs, there exists a method of allocating each one CPU to the virtual computer 40 and specifying a CPU utilization thereof. In this case, for example, it is enabled to specify the CPU utilization of the virtual computer 1 as 10% and those of the virtual computers 2 to 4 as 30%, respectively.

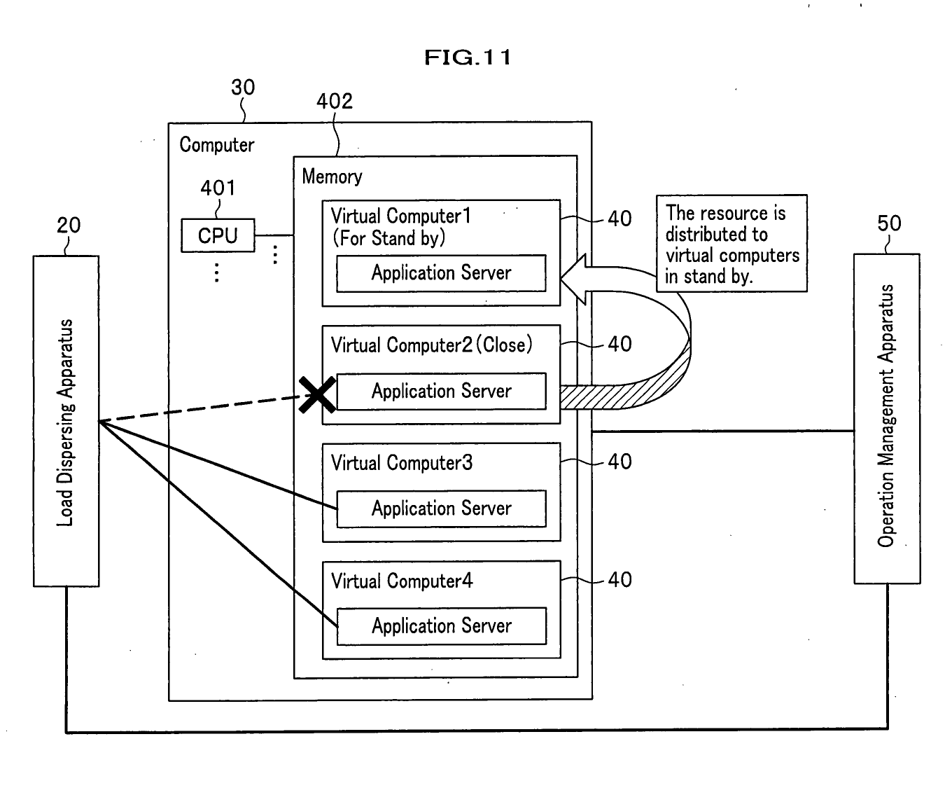

Although in the second embodiment an extra resource of the virtual computer 40 of the reset object is allocated to the active virtual computers 40, in the third embodiment as shown in FIG. 11, the extra resource is allocated to the virtual computer 40 for standby. FIG. 14 is a drawing showing a status after a resource is allocated. Because the virtual computer 2 is reset here, an extra resource (12 CPUs) allocated to the virtual computer 2 is allocated to the virtual computer 40 (virtual computer 1) for standby. Meanwhile, in a case of using a method of allocating each one CPU to each virtual computer 40 and specifying a CPU utilization thereof, it is enabled, for example, to specify the CPU utilization of the virtual computer 2 as 10% and those of the virtual computers 1, 3, and 4 as 30%, respectively.

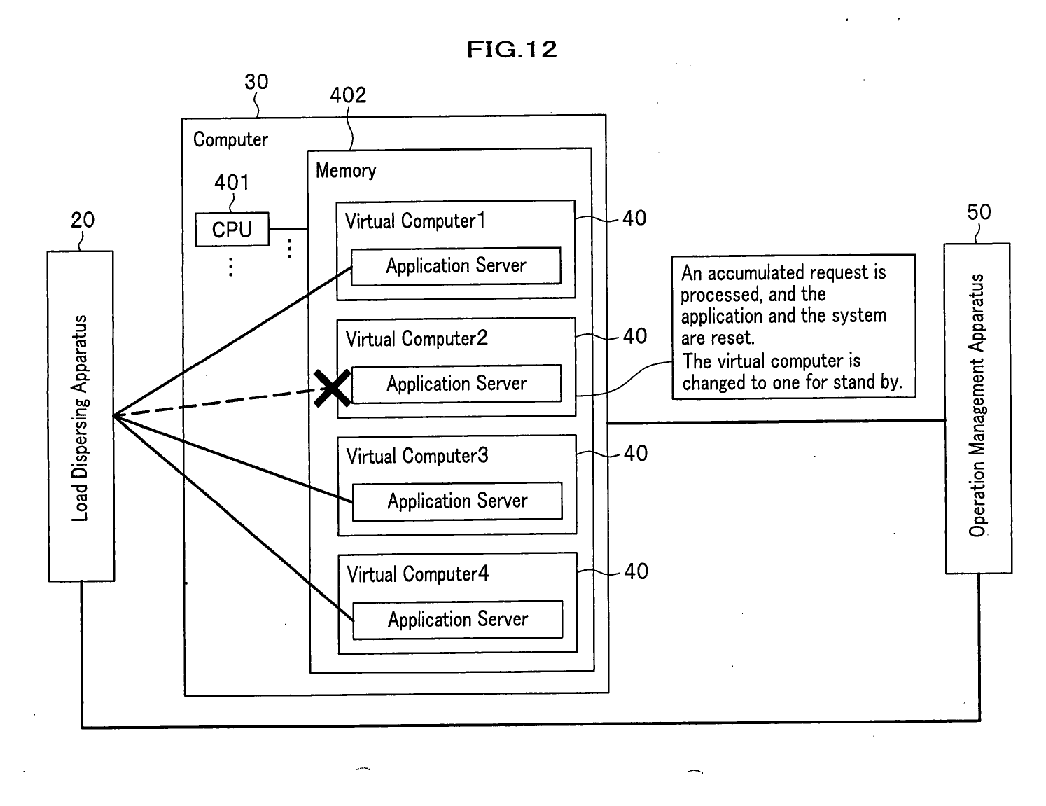

As an actual operation, because the resource of the virtual computer 40 (virtual computer 1) for standby results in increasing, the operation management apparatus 50 performs an allocation change instruction to the load dispersing apparatus 20 so as to allocate the request allocated to the virtual computer 40 (virtual computer 2) of the reset object to the virtual computer 40 for standby, and thereby, makes the virtual computer 40 of the reset object a standby status. FIG. 12 is a drawing showing a status after an allocation destination is changed. Then the operation management apparatus 50 performs a reset processing instruction to the virtual computer 40 of the reset object.

The virtual computer 40 (virtual computer 2) receives the reset processing instruction from the operation management apparatus 50, then firstly, allocates a part of the resource to the virtual computer 40 (virtual computer 1) for standby, and performs own close. Next, after processing a request accumulated before the close, the virtual computer 2 performs the reset processing. Then after releasing the close, the virtual computer 2 operates as a virtual computer 40 for standby as it is. To the virtual computer 40 (virtual computer 1) for standby is allocated a request from the load dispersing apparatus 20 that has received the allocation change instruction, and thus thereto is allocated a part of the resource from the virtual computer 40 (virtual computer 2) that has received the reset processing instruction; and thereby, the virtual computer 1 continues processing as an active virtual computer 40 as it is. In a case of resetting a next virtual computer 40, a virtual computer 40 that receives the reset processing instruction allocates a resource to another virtual computer 40, which completed the reset processing just before and has become the virtual computer 40 for standby, and then, the reset processing is repeated.

In accordance with the third embodiment thus described, because an extra resource can be effectively utilized even in reset processing and a number of active virtual computers 40 does not decrease, it is enabled to operate the computer 30 in a status not different from normal operation. Therefore, it is enabled to operate the computer 30 without almost lowering the processing efficiency thereof.

Thus although the embodiments of the present invention are described, it is assumed that an information processing system related to the embodiments is realized by: recording a program run in each part of the information processing system 100 shown in FIG. 1 in a recording medium readable by computer; reading the program recorded in the recording medium into a computer system; and performing the program. Meanwhile, it is also available to provide the computer system with the program via network such as the Internet. Furthermore, it is also available to provide a semiconductor chip where the program is written.

### Other Embodiments

Thus although three examples of the preferred embodiments of the present invention are described, the invention is not limited thereto; Various variations are available without departing from the spirit and scope of the invention. For example, embodiments below are available:

(1) Although in the embodiments the information processing system 100 is described so as to comprise the terminals 10, the load dispersing apparatus 20, the computer 30, and the operation management apparatus 50, it may also not comprise the load dispersing apparatus 20. In this case any of the virtual computers 40 within the computer 30 is adapted to directly receive a request from any of the terminals 10.

(2) In the embodiments, although CPUs and a memory are set as the resource allocation management table 420, other resources such as an I/O slot and a hard disk drive may also be set.

(3) In the embodiments, although in the information processing system 100 the terminals 10 and the load dispersing apparatus 20 are described so as to be connected via the network 60, another connection mode is also available: for example, the information processing system 100 is one computer; the terminals 10 are a keyboard, a mouse, and a display; the computer 30 (virtual computers 40) is a configuration of controlling the computer in total; and the terminals 10 and the load dispersing apparatus 20 are connected with I/O cables.

(4) Although in the embodiments the operation management apparatus 50 is described so as to be connected to one load dispersing apparatus 20 and one computer 30, it may also be a configuration of being connected to a plurality of load dispersing apparatuses 20 and a plurality of computers 30. In this case the operation management apparatus 50 is configured such that: a plurality of reset processing time setting tables 530 and computer status management tables 540 respectively corresponding to the computers 30, and a plurality of load dispersing allocation management tables 550 respectively corresponding to the load dispersing apparatuses 20 are included in the memory 502 of the operation management apparatus 50.

What is claimed is:

1. A computer control method for opening a memory area of not less than two virtual computers in an information processing system that has a computer communicable with a terminal for sending a predetermined request and equipped with the virtual computers for processing a request received from the terminal, and an operation management apparatus communicable with the virtual computers and for performing a reset processing instruction to the virtual computers, the method comprising the steps of:
making said operation management apparatus sequentially perform said reset processing instruction one by one to said virtual computers managed by a memory unit, wherein the operation management apparatus comprises said memory unit configured to manage said virtual computers within said computer; and
making said virtual computers perform own reset processing when receiving said reset processing instruction from said operation management apparatus.

2. The computer control method according to claim 1, said information processing system further comprising:
a load dispersing apparatus communicable with said terminal, said virtual computers, and said operation management apparatus and configured to allocate a request received from said terminal,
wherein said operation management apparatus performs an allocation change instruction to said load dispersing apparatus not to allocate said request to said virtual computers before performing said reset processing instruction to said virtual computers, and
wherein when receiving said allocation change instruction, said load dispersing apparatus performs an allocation change according to said allocation change instruction.

3. The computer control method according to claim 1, wherein when receiving said reset processing instruction from said operation management apparatus, said virtual computers close themselves, then process not processed request, perform own reset processing, and after then, release own close.

4. The computer control method according to claim 3, wherein when receiving said reset processing instruction, said virtual computers allocate a part of a resource to other virtual computers before closing themselves, release own close, and after then, return the part of the allocated resource to themselves.

5. The computer control method according to claim 3, said computer further comprising:
a virtual computer for standby,
wherein when performing said allocation change instruction, said operation management apparatus further instructs to allocate said request to said virtual computer for standby,
wherein when receiving said allocation change instruction, said load dispersing apparatus further performs an allocation change to allocate said request to said virtual computer for standby,
wherein when receiving said reset processing instruction, said virtual computers allocate a part of a resource to said virtual computer for standby before closing themselves, and newly operate themselves as a virtual computer for standby after releasing own close, and
wherein to an initial virtual computer for standby is allocated said request from said load dispersing apparatus that receives said allocation change instruction, and said initial virtual computer newly operates as an active virtual computer by the part of said resource being allocated from a virtual computer that receives said reset processing instruction.

6. The computer control method according to claim 1, wherein a timing when said operation management apparatus performs any one of said reset processing instruction and said allocation change instruction is defined by monitoring a start time of any one of said reset processing instruction and said allocation change instruction stored in said memory unit.

7. The computer control method according to claim 1, wherein a timing when said operation management apparatus performs any one of said reset processing instruction and said allocation change instruction is defined by monitoring a start time of any one of said reset processing instruction and said allocation change instruction stored in said memory unit, and a reset interval time between said virtual computers.

8. An information processing system comprising:
a computer that is communicable with a terminal configured to send a predetermined request and comprises not less than two virtual computers configured to process a request received from said terminal; and
an operation management apparatus communicable with said virtual computers and configured to perform a reset processing instruction to said virtual computers,
wherein said operation management apparatus comprises a memory unit configured to manage said virtual computers within said computer, and a processing unit configured to sequentially perform a reset processing instruction one by one to said virtual computers managed by said memory unit in order to open a memory area of said virtual computers within said computer,
wherein when receiving said reset processing instruction from said operation management apparatus, said virtual computers perform own reset processing.

9. An information processing system according to claim 8 further comprising:
a load dispersing apparatus communicable with said terminal, said virtual computers, and said operation management apparatus, and configured to allocate a request received from said terminal to said virtual computers,
wherein said operation management apparatus performs an allocation change instruction to said load dispersing apparatus not to allocate said request to said virtual computers before performing said reset processing instruction to said virtual computers, and
wherein when receiving said allocation change instruction from said operation management apparatus, said load dispersing apparatus performs an allocation change according to said allocation change instruction.

10. An information processing system according to claim 8, wherein when receiving said reset processing instruction from said operation management apparatus, said virtual computers close themselves, then process not processed request, perform own reset processing, and after then, release own close.

11. An operation management apparatus communicable with a computer that is communicable with a terminal for sending a predetermined request, is equipped with not less than two virtual computers for processing a request received from the terminal, and performs a reset processing instruction to the virtual computers, the apparatus comprising:
a memory unit configured to manage said virtual computers within said computer; and
a processing unit configured to sequentially perform said reset processing instruction one by one to said virtual computers managed by said memory unit in order to open a memory area of the virtual computers within said computer,

12. The operation management apparatus according to claim 11 communicable with said terminal and said virtual computers and further with a load dispersing apparatus for allocating a request received from the terminal to the virtual computers,
wherein the processing unit of said operation management apparatus performs an allocation change instruction to said load dispersing apparatus not to allocate said request to said virtual computers before performing said reset processing instruction to the virtual computers.

13. A computer communicable with any one of a terminal for sending a predetermined request and a load dispersing apparatus for allocating a request received from the terminal, the computer comprising:
not less than two virtual computers configured to process a request received from any one of said terminal and said load dispersing apparatus,
wherein said virtual computers are further communicable with an operation management apparatus, and performs own reset processing when receiving said reset processing instruction from said operation management apparatus.

14. A computer according to claim 13, wherein when receiving said reset processing instruction, said virtual computers close themselves, then process not processed request, perform own reset processing, and after then, release own close.

15. A program for opening a memory area of not less than two virtual computers in an information processing system that has a computer communicable with a terminal for sending a predetermined request and equipped with the virtual computers for processing a request received from the terminal, and an operation management apparatus communicable with the virtual computers and for performing a reset processing instruction to the virtual computers, the program comprising the steps of:
making said operation management apparatus sequentially perform said reset processing instruction one by one to said virtual computers managed by a memory unit, wherein the operation management apparatus comprises said memory unit configured to manage the virtual computers within said computer; and
making said virtual computers perform own reset processing when receiving said reset processing instruction from said operation management apparatus.

16. The program according to claim 15, said information processing system further equipped with a load dispersing apparatus communicable with said terminal, said virtual computers, and said operation management apparatus, and for allocating a request received from the terminal to the virtual computers, the program further comprising the steps of:
making said operation management apparatus perform an allocation change instruction to said load dispersing apparatus not to allocate said request to said virtual computers before performing said reset processing instruction to said virtual computers; and
making said load dispersing apparatus perform an allocation change according to said allocation change instruction when receiving said allocation change instruction.

17. The program according to claim 15 further comprising the step of:
making said virtual computers close themselves, then process not processed request, perform own reset processing, and after then, release own close, when receiving said reset processing instruction from said operation management apparatus.

18. The program according to claim 17 further comprising the step of:
making said virtual computers allocate a part of a resource to other virtual computers before closing themselves, release own close, and after then, return the part of the allocated resource to themselves, when receiving said reset processing instruction.

19. The program according to claim 17, said computer further equipped with a virtual computer for standby, the program further comprising the steps of:
making said operation management apparatus further instruct to allocate said request to said virtual computer for standby when performing said allocation change instruction;
making said load dispersing apparatus further perform an allocation change to allocate said request to said virtual computer for standby when receiving said allocation change instruction;
making said virtual computers allocate a part of a resource before closing themselves, and newly operate themselves as a virtual computer for standby after releasing own close, when receiving said reset processing instruction; and
making an initial virtual computer for standby allocated said request from said load dispersing apparatus that receives said reset processing instruction, and newly operate as an active virtual computer by the part of said resource being allocated from a virtual computer that receives said reset processing instruction.

20. The program according to claim 15 further comprising the step of:
defining a timing when said operation management apparatus performs any one of said reset processing instruction and said allocation change instruction by monitoring a start time of any one of said reset processing instruction and said allocation change instruction stored in said memory unit.

21. The program according to claim 15 further comprising the step of:
defining a timing when said operation management apparatus performs any one of said reset processing instruction and said allocation change instruction by monitoring a start time of any one of said reset processing instruction and said allocation change instruction stored in said memory unit and a reset interval time between said virtual computers.
